(19) United States
(12) Patent Application Publication
(10) Pub. No.: US 2012/0034892 A1
(43) Pub. Date: Feb. 9, 2012

(54) HIGH-RATE WIRELESS RECEIVING APPARATUS

(75) Inventor: Chan Yong JEONG, Seoul (KR)

(73) Assignee: SAMSUNG ELECTRO-MECHANICS CO., LTD., Gyunggi-do (KR)

(21) Appl. No.: 12/982,112

(22) Filed: Dec. 30, 2010

(30) Foreign Application Priority Data
Aug. 6, 2010 (KR) 10-2010-0076101

(51) Int. Cl. H04B 1/06; H04B 1/16

(52) U.S. Cl. 455/227; 455/269

(57) ABSTRACT

There is provided a high-rate wireless receiving apparatus which can effectively receive a wireless signal even in a Non-Line of Sight state by using a millimeter-wave band (e.g., 60 GHz) or a THz frequency band (100 GHz or above). The high-rate wireless receiving apparatus includes an antenna receiving a high-rate wireless signal, a radio frequency processing unit processing the high-rate wireless signal received from the antenna to thereby generate a base-band signal, a base-band processing unit processing the base-band signal to thereby generate information data included in the high-rate wireless signal, and a reception information data storing unit storing the information data.

### CROSS-REFERENCE TO RELATED APPLICATIONS

This application claims the priority of Korean Patent Application No. 10-2010-0076101 filed on Aug. 6, 2010, in the Korean Intellectual Property Office, the disclosure of which is incorporated herein by reference.

### BACKGROUND OF THE INVENTION

1. Field of the Invention

The present invention relates to a high-rate wireless receiving apparatus, and more particularly, to a high-rate wireless receiving apparatus which can effectively receive a wireless signal even in a Non-Line Of Sight state by using a millimeter-wave band (e.g., 60 GHz) or a THz frequency band (100 GHz or above).

2. Description of the Related Art

Recently, in the fields of household appliances or personal computers, there has been an increasing demand for expansion of product lines which use high-definition and high-capacity information, as well as for an upgrade of existing product lines to support a wireless communication.

For example, in the field of household appliances, there have been expanded new product lines (e.g., 3D LED TV, and blueray), which process high-definition and high-capacity information, over existing product lines. In the field of PCs, with the development of a high-rate data interface technology like Bluetooth 3.0 and USB 3.0, new product lines have been introduced which can transmit data by using the developed interfaces. Due to mounting demand for the development of new or existing product lines as described above, there has been required a technology in which high-definition and high-capacity information can be wirelessly transmitted/received at a high rate.

In order to meet the technical demand therefor, an uncompressed A/V streaming technology has been proposed which uses a wireless signal with the 60 GHz band in the field of the related art.

As such, a wireless-transmission technology for using a frequency of a millimeter-wave band or above (e.g, 60 GHz) has an advantage in that high-capacity information can be transmitted at a high rate. However, the wireless-transmission technology has a disadvantage in that the millimeter-wave length is so short, and thus directionality is too strong to transmit a signal in a Non-Line Of Sight (NLOS) state.

In order to overcome this disadvantage, the number of antennas is increased, and a beam forming algorithm is applied to each of the antennas, so as to improve a signal reception rate by the antennas. However, the addition of such functions causes an increase in a chipset's size and power consumption. Therefore, this function-addition has been partially applied only to a restricted field.

As a result, there is a need to provide a technology for improving a reception performance of a wireless signal with a millimeter-wave band or a THz frequency band, even in an NLOS state.

### SUMMARY OF THE INVENTION

An aspect of the present invention provides a high-rate wireless receiving apparatus which can effectively receive a wireless signal even in a Non-Line Of Sight state by using a millimeter-wave band (e.g., 60 GHz) or a THz frequency band (100 GHz or above).

According to an aspect of the present invention, there is provided a high-rate wireless receiving apparatus including: an antenna receiving a high-rate wireless signal; a radio frequency processing unit processing the high-rate wireless signal received from the antenna to thereby generate a base-band signal; a base-band processing unit processing the base-band signal to thereby generate information data included in the high-rate wireless signal; and a reception information data storing unit storing the information data.

The antenna may include a plurality of radiation patches which are disposed to have a plurality of rows and columns.

The high-rate wireless receiving apparatus may further include a high-rate interface unit through which the information data stored in the reception information data storing unit is outputted to the outside of the high-rate wireless receiving apparatus.

The high-rate interface unit may include at least one of a USB 2.0, a USB 3.0, a PCI-Express, and a High Definition Multimedia Interface (HDMI).

The high-rate wires signal may correspond to a wireless signal with a millimeter-wave band or a THz frequency band.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing a high-rate wireless receiving apparatus according to an exemplary embodiment of the present invention;

FIG. 2 is a bock diagram showing a high-rate wireless receiving apparatus according to another exemplary embodiment of the present invention;

FIG. 3 is a top view showing an antenna to which the embodiment of the present invention is applied; and

FIG. 4 is a flowchart showing an operation of the high-rate wireless receiving apparatus according to an exemplary embodiment of the present invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

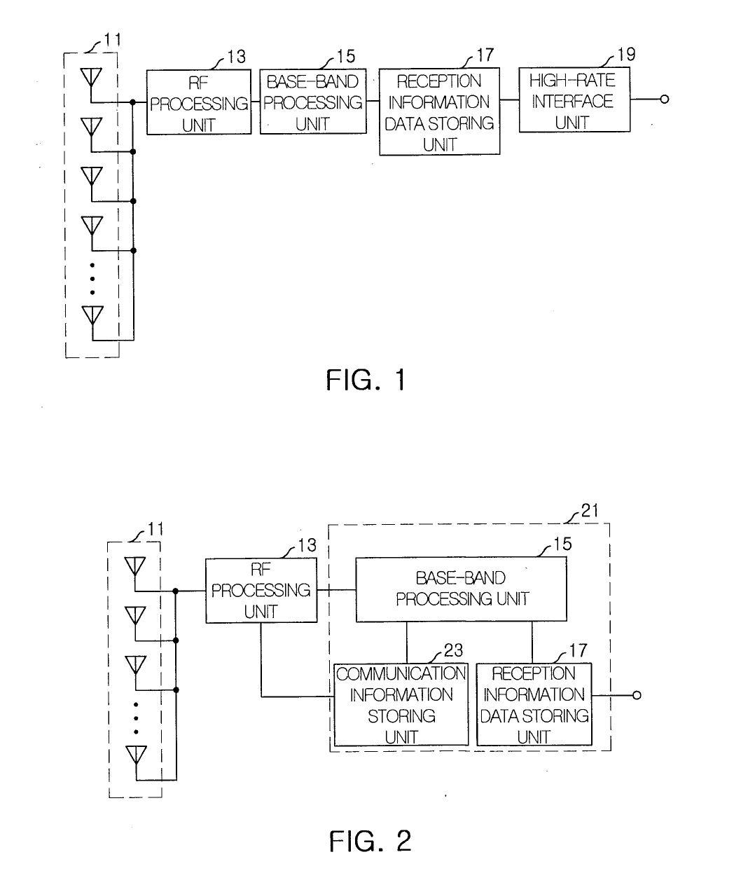

FIG. 1 is a block diagram showing a high-rate wireless receiving apparatus according to an exemplary embodiment of the present invention.

As shown in FIG. 1, the high-rate wireless receiving apparatus may include an antenna 11, a Radio Frequency (RF) processing unit 13, a base-band processing unit 15, and a reception information data storing unit 17. The antenna 11 receives a high-rate wireless signal, and the RP processing unit 13 processes the high-rate wireless signal received from the antenna 11 to thereby generate the base-band signal. The base-band processing unit 15 processes the base-band signal to thereby generate information data included in the high-rate wireless signal. The reception information data storing unit 17 stores the information data.

In addition, in the exemplary embodiment of the present invention, the high-rate wireless receiving apparatus may further include a high-rate interface unit 19 through which the information data stored in the reception information data storing unit 17 is outputted to the outside of the high-rate wireless receiving apparatus.

FIG. 2 is a bock diagram showing a high-rate wireless receiving apparatus according to another exemplary embodiment of the present invention.

As shown in FIG. 2, the high-rate wireless receiving apparatus according to another exemplary embodiment of the present invention may include an antenna 11, an RF processing unit 13, a base-band processing unit 15, and a base-band chipset 21. The antenna 11 receives a high-rate wireless signal, and the RF processing unit 13 processes the high-rate wireless signal received from the antenna 11 to thereby generate the base-band signal. The base-band processing unit 15 processes the base-band signal to thereby generate information data contained in the high-rate wireless signal, and the base-band chipset 21 includes a reception information data storing unit 17 which stores the information data.

In the exemplary embodiment of the present invention, the reception information data storing unit 17 and the base-band processing unit 15 of FIG. 1 are formed into a single chipset 21. The base-band processing unit 15 may include a communication information storing unit 23 which may be constructed separately from the reception information data storing unit 17. The communication information storing unit 23 may store communication information, such as commands required for wireless communication, instead of content data in a reception signal (e.g., audio/image data). Therefore, the reception information data storing unit 17 may be constructed to have a high capacity (e.g., 1 GB or higher), for storing the content data like mass-data. The communication information storing unit 23 may be constructed to have a low capacity (e.g., about 256 KB).

Although not shown in the drawings, the high-rate wireless receiving apparatus according to another exemplary embodiment of the present invention may further include a high-rate interface unit 19 through which the information data stored in the reception information data storing unit 17 is outputted to the outside of the high-rate wireless receiving apparatus.

Hereinafter, a detailed description will be given of respective components according to exemplary embodiments of the present invention of FIGS. 1 and 2.

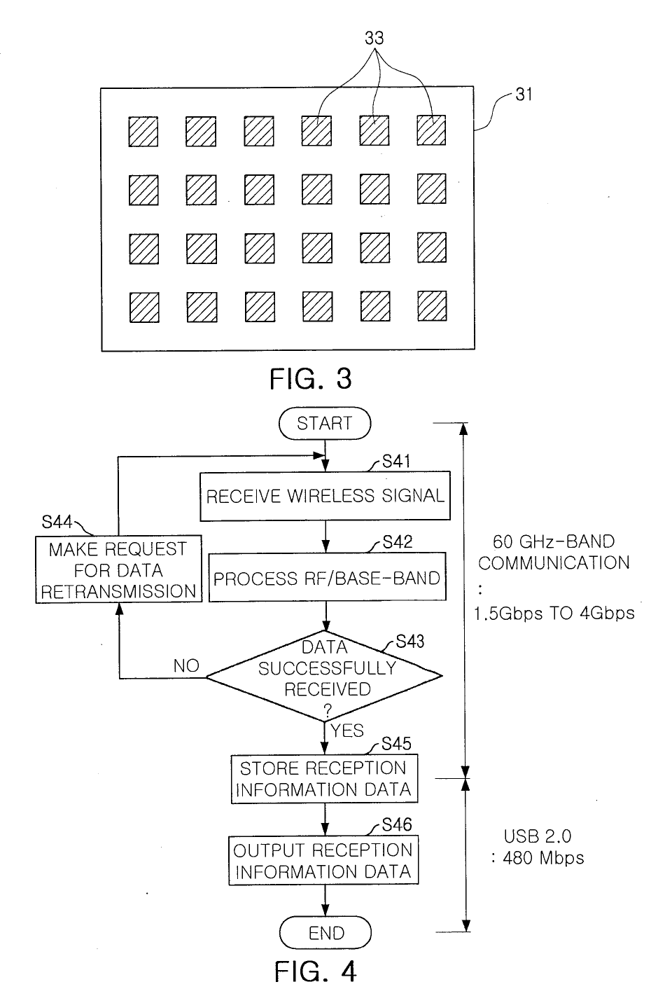

The antenna 11 receives a high-rate wireless signal, and the structure thereof will be illustrated in FIG. 3. FIG. 3 is a top view showing an antenna to which the exemplary embodiment of the present invention is applied.

As shown in FIG. 3, the antenna 11 may be constructed with a plurality of radiation patches 33 which are disposed on a substrate 31 in such a manner as to have a plurality of columns and rows. The structure of the antenna 11 with a plurality of radiation patches is to prevent data loss due to the directionality of a signal with a millimeter wave or a THz frequency band to which the embodiment of the present invention is applied, in a state of a Non Line of Sight. According to the exemplary embodiment of the present invention, it is possible to minimize data loss by the antenna, by applying a beam forming technique to each of radiation patches in the antenna so that a beam is formed to have an optimal shape.

When the number of the radiation patches is increased in the antenna 11 with the above-described structure, a reception rate may be increased in a state of NLOS. However, of adjusts the size of a block which adjusts the radiation patches 33, as well as the size of a beam forming block which performs a beam forming for each of the radiation patches 33 may be increased. In particular, since a Low Noise Amplifier (LNA) should be arranged on each of the radiation patches 33, mounting spaces for additional circuits are increasingly required according to an increase in the number of the radiation patches 33. Thus, the present invention aims at increasing a reception efficiency of the high-rate wireless signal in a state in which there is no increase in the number of the radiation patches 33.

The RF processing unit 13 converts a High-Frequency (HF) signal inputted from the antenna 11 into a base-band signal. For example, the RF processing unit 13 may include an LAN (not shown) and a mixer (not shown). The LAN amplifies the wireless signal received from the antenna 11, and the mixer converts the HF signal into a base-band signal. The RF processing unit 13 may be constructed in the form of a single chipset or a module. In addition, adjustment blocks in the radiation patches 33 may be integrated with the RF processing unit 13 to thereby be formed into a single chipset or a module.

The base-band processing unit 15 processes the base-band signal to thereby generate data within the high-rate wireless signal. The base-band processing unit 15 may include an analog to digital converter, a modulator, a digital signal processor, in order to process a base-band signal.

The base-band processing unit 15 and the reception information data storing unit 17 may be integrated with each other to thereby be formed into a single chipset or a module, as in the case of FIG. 2.

The reception information data storing unit 17 stores information data outputted from the base-band processing unit 15, that is, data containing a desired content to be transmitted. The reception information data storing unit 17 may be constructed with a memory space which has a sufficient capacity (e.g., 1 GB or higher) enough to store data corresponding to one or more compact discs (CDs).

The high-rate interface unit 19 is used to output the information data stored in the reception information data storing unit 17 to the outside of the high-rate wireless receiving apparatus. In a case where an external apparatus connected to the high-rate wireless receiving apparatus is a TV, or a Personal Computer (PC), the high-rate interface unit 19 may include one of a USB 2.0, a USB 3.0, a PCI Express (PCIe), and an HDMI.

Hereinafter, an operation and an effect according to the exemplary embodiment of the present invention will be described in more detail.

FIG. 4 is a flow chart showing an operation of the high-rate wireless receiving apparatus according to the exemplary embodiment of the present invention.

A detailed description will be given of an operation of the high-rate wireless receiving apparatus according to the exemplary embodiment of the present invention, with reference to FIGS. 1 to 4.

First, a signal with a THz frequency band or a millimeter wave is received through the antenna 11 in operation S41. Each of the RF processing unit 13 and the base-band processing unit 15 processes the RF signal and base-band signal in operation S42.

It is determined whether data has been normally received according to analysis of data received in the operation above. When it is determined that the data has not been normally received, a request for data retransmission is made in operation S44. When it is determined that the data has been normally received, the information data received through the antenna is stored in the reception information data storing unit 17 in operation S45.

The data stored in the reception information data storing unit 17 is outputted to external devices of the high-rate wireless receiving apparatus through the high-rate interface unit 19 in operation S46.

For example, it is assumed that a USB 2.0 is used as the interface in a 60 GHz-band communication. The high-rate wireless receiving apparatus receives data at a transmission rate of about 1.5 Gbps to 4 Gbps, and the data transmission standard of the USB 2.0 used as the high-rate interface unit 19 is 480 Mbps. Therefore, the base-band processing unit 15 outputs information data at a data transmission rate of 1.5 Gbps to 4 Gbps, but the USB 2.0 supports only a data transmission rate of 480 Mbps, which results in a bottleneck phenomenon in which received data is not directly outputted to the outside. In this case, the high-rate wireless receiving apparatus cannot help performing a communication at a slow speed of the interface, instead of a self-supportable maximum speed.

In the exemplary embodiment of the present invention, the high-rate wireless receiving apparatus is provided with the reception information data storing unit 17, so that it is possible to adjust the bottleneck phenomenon due to a speed difference between the high-rate wireless receiving apparatus and the interface. Therefore, the high-rate wireless receiving apparatus can always perform data communication at a high rate.

In addition, even though a request for data retransmission is made due to reception errors in the NLOS state, no influence may be given data outputted through the interface.

For another example, it is assumed that the high-rate wireless receiving apparatus of the present invention provides an A/V streaming service. In general, in a case where the A/V streaming service is provided in real time, when reception errors occur in the Non-Line of Sight state, the data is discontinuously provided to a TV or a monitor, resulting in low quality of image and sound.

The high-rate wireless receiving apparatus according to the exemplary embodiment of the present invention is provided with the reception information data storing unit 17, thereby storing information data received in advance, and then providing the stored data to a TV, or a monitor. In addition, even though all information data is not stored, the outputting of the previously stored data and the storing of a subsequent data may be performed at the same time.

In particular, it takes only 1 to 4 seconds for the high-rate wireless receiving apparatus to receive data (e.g., one CD) with a capacity of 700 MB in a 60 GHz-grade communication. This is because that data transmission rate is 1.5 Gbps to 4 Gbps. Therefore, a case in which data is stored in the reception information data storing unit 17, and then the stored data is outputted is nearly similar to a case in which A/V streaming provided in real time is enjoyed, in terms of actual view point.

In a case where the A/V streaming service is provided, when a request for data retransmission is made due to the occurrence of a reception error in the Non-Line of Sight (NLOS) state, storing and outputting may be performed in a separate manner through the reception information data storing unit 17. Therefore, it is possible to continuously provide an A/V streaming service at a high quality.

According to the exemplary embodiment of the present invention, it is possible to ensure the quality of data provided through a high-rate wireless reception technology which uses a signal with a millimeter-wave band or a THz band, even in an NLOS state.

Moreover, it is possible to always receive a signal at a maximum rate by solving a bottleneck phenomenon generated due to a speed difference between a high-rate wireless receiving apparatus and an interface connected to the outside.

Furthermore, it is possible to provide continuously an A/V streaming service through a high-rate wireless receiving apparatus which can effectively receive a signal even in an NLOS by using a millimeter-wave band or a THz frequency band.

While the present invention has been shown and described in connection with the exemplary embodiments, it will be apparent to those skilled in the art that modifications and variations can be made without departing from the spirit and scope of the invention as defined by the appended claims.

What is claimed is:

1. A high-rate wireless receiving apparatus comprising:
an antenna receiving a high-rate wireless signal;
a radio frequency processing unit processing the high-rate wireless signal received from the antenna to thereby generate a base-band signal;
a base-band processing unit processing the base-band signal to thereby generate information data included in the high-rate wireless signal; and
a reception information data storing unit storing the information data.

2. The high-rate wireless receiving apparatus of claim 1, wherein the antenna includes a plurality of radiation patches which are disposed to have a plurality of rows and columns.

3. The high-rate wireless receiving apparatus of claim 1, further comprising a high-rate interface unit through which the information data stored in the reception information data storing unit is outputted to the outside of the high-rate wireless receiving apparatus.

4. The high-rate wireless receiving apparatus of claim 3, wherein the high-rate interface unit includes at least one of a USB 2.0, a USB 3.0, a PCI-Express, and a High Definition Multimedia Interface (HDMI).

5. The high-rate wireless receiving apparatus of claim 1, wherein the high-rate wireless signal corresponds to a wireless signal with a millimeter-wave band or a THz frequency band.
